(19) United States
(12) Patent Application Publication
(10) Pub. No.: US 2021/0078174 A1
(43) Pub. Date: Mar. 18, 2021

(54) INTELLIGENT MEDICAL MATERIAL SUPPLY ROBOT BASED ON INTERNET OF THINGS AND SLAM TECHNOLOGY

(71) Applicant: Wuyi University, Jiangmen (CN)

(72) Inventors: Chuanbo QIN, Jiangmen (CN); Jingyin LIN, Jiangmen (CN); Junying ZENG, Jiangmen (CN); Fan WANG, Jiangmen (CN); Zhongwen LIANG, Jiangmen (CN); Ziyu SONG, Jiangmen (CN); Weizhao HE, Jiangmen (CN)

(21) Appl. No.: 16/806,711

(22) Filed: Mar. 2, 2020

(30) Foreign Application Priority Data
Sep. 17, 2019 (CN) 2019108747504

(51) Int. Cl. B25J 9/16; A61G 12/00; B25J 5/00

(52) U.S. Cl. CPC B25J 9/1666; B25J 5/007; A61G 12/001

(57) ABSTRACT

An intelligent medical material supply robot based on Internet of Things and SLAM technology is disclosed, which realizes localization and mapping through a binocular camera and a lidar. A cloud data center schedules the medical material supply robot in real time according to material usage. The material supply robot receives corresponding scheduling information, and according to localization of the robot and map information, dynamically avoids obstacles by using a path planning algorithm to go to a designated floor for materials delivery.

### CROSS-REFERENCE TO RELATED APPLICATIONS

This application is based on and claims the benefit of priority from Chinese Patent Application No. 2019108747504, filed on 17 Sep. 2019, the entirety of which is incorporated by reference herein.

### TECHNICAL FIELD

The present disclosure relates to the technical field of material transportation, and in particular, to an intelligent medical material supply robot based on Internet of Things and SLAM technology.

### BACKGROUND

The supply of medical materials is an essential part of the daily operation of the hospital. Medical services such as medical treatment, examination and hospitalization are accompanied by consumption of medical materials. However, there are a large number of patients and inpatients in the hospital every day, the consumption of various medical materials is huge, and storage space at medical material sites such as hospital pharmacies is limited. Therefore, medical materials need to be supplied frequently, and the statistics of usage of various materials are also difficult. Through the monitoring of the cloud data center, the material supply robot can timely supply medical materials and make statistics on their usage.

At present, the transportation of medical materials in domestic hospitals is still dominated by manual transportation, which often has problems of untimely supply of materials and difficult counting of the quantity of materials. In addition, the current manual transportation is inefficient, which consumes some human resources in the hospitals.

### SUMMARY

The present disclosure aims at providing an intelligent medical material supply robot based on Internet of Things and SLAM technology to address at least one of the technical problems existing in the prior art, which can take the place of the medical staff to autonomously carry medical materials to designated locations, saving manpower and improving transportation efficiency.

The intelligent medical material supply robot based on Internet of Things and SLAM technology according to embodiments of the present disclosure comprises:

an environment sensing module provided with a binocular camera and a lidar, wherein the binocular camera acquires image information by real-time shooting, and the lidar obtains map information by sensing spatial information;

a data processing module for analyzing the image information captured by the binocular camera, making incremental calculation of position and pose of the robot based on inter-frame information in the image information, and completing judgment on a static obstacle and a dynamic obstacle by analyzing the map information sensed by the lidar;

a motion module provided with a Mecanum wheel and a motor, wherein the Mecanum wheel is driven by the motor;

a control module provided with a central processing unit for receiving and processing the data acquired by the environment sensing module and a main control board for controlling the motion module; and

a cloud data center comprising a cloud server, configured for analyzing material usage at current and previous moments and transmitting the data to the control module.

The intelligent medical material supply robot based on Internet of Things and SLAM technology according to the embodiments of the present disclosure has at least the following technical effects: localization and mapping are realized through a binocular camera and a lidar. A cloud data center schedules the medical material supply robot in real time according to material usage. The material supply robot receives corresponding scheduling information, and according to localization of the robot and map information, dynamically avoids obstacles by using a path planning algorithm to go to a designated floor for materials delivery.

According to some embodiments of the present disclosure, the lidar emits a laser beam which will reflect when encountering an obstacle, and a distance between the robot and the obstacle is calculated by the lidar based on the following calculation formulas:

$$q = \frac{fs}{x}$$

$$d = \frac{q}{sin β}$$

$$\frac{dq}{dx} = - \frac{{q}^{2}}{fs}$$

where an emission angle β is a known quantity, q is a measured distance, s is a distance between a laser head and a lens, f is a focal length of the lens, and x corresponds to s in an imager.

According to some embodiments of the present disclosure, the control module adopts a PID adjustment algorithm, and a calculation formula of its control law is as follows:

$$u ( t ) = {k}_{p} [ error ( t ) + \frac{1}{{T}_{t}} {\int }_{0}^{t} error ( t ) dt + \frac{{T}_{D} derror ( t )}{dt} ]$$

$$error ( t ) = {y}_{d} ( t ) - y ( t )$$

where K is a proportionality coefficient, TI is an integral time constant, TD is a differential time constant, error(t) is a deviation signal, yd(t) is a given value, and y(t) is an output value.

According to some embodiments of the present disclosure, the motion module comprises four Mecanum wheels and four motors corresponding to the Mecanum wheels one by one, and the Mecanum wheels are driven by the motors to move in any direction on the horizontal plane under the control of the main control board.

According to some embodiments of the present disclosure, the omnidirectional movement of the Mecanum wheel(s) is realized by using forward and inverse kinematics models.

According to some embodiments of the present disclosure, the data processing module constructs a map by using the SLAM technology based on an ROS system.

According to some embodiments of the present disclosure, after giving a target point, the cloud data center first determines the robot's current position and pose, calculates a distance between the robot and an obstacle by the lidar, converts obstacle information into a grid map applicable to path planning, calculates, by using a global path planning algorithm, an optimal path that the robot can move along currently, constantly senses changes of environment information in the process of moving, and avoids dynamic obstacles by using a local path planning algorithm.

Additional aspects and advantages of the present disclosure will be given in the following description, and some of which will be understood by practice of the present disclosure.

### BRIEF DESCRIPTION OF THE DRAWINGS

The above and/or additional aspects and advantages of the present disclosure will become obvious and easy to understand from the description about the embodiments with reference to the following accompanying drawings, in which:

FIG. 1 is a schematic structural block diagram according to an embodiment of the present disclosure;

FIG. 2 is a block diagram of the working principle according to an embodiment of the present disclosure;

FIG. 3 is a schematic diagram of lidar triangulation ranging; and

FIG. 4 is a flowchart of an automatic obstacle avoidance algorithm Dynamic Window Approach (DWA).

### DETAILED DESCRIPTION

Specific embodiments of the present disclosure will be described in detail in this section. Preferred embodiments of the present disclosure are shown in the accompanying drawings whose function is to supplement the description of the text part of the specification with graphics, so that each technical feature and the overall technical scheme of the present disclosure can be intuitively and vividly understood, but it cannot be construed as limiting the protection scope of the present disclosure.

In the description of the present disclosure, it should be understood that orientation descriptions involved, for example, orientation or position relationships indicated by up, down, front, back, left, right, and so on, are based on the orientation or position relationships shown in the accompanying drawings, and they are intended only to facilitate the description of the present disclosure and simplify the description, rather than indicating or implying that the apparatus or components referred to must have a specific orientation and be constructed and operated in a specific orientation, and thus cannot be understood as limiting the present disclosure.

In the description of the present disclosure, “several” means one or more, and “multiple” means more than two, “greater than, less than, more than, etc.,” are understood as not including the number itself, while “above, below, within, etc.,” are understood as including the number itself. It should be noted that the terms first and second are only used to distinguish technical features, and cannot be understood as indicating or implying relative importance or implicitly indicating the number of technical features indicated or implicitly indicating the precedence of the technical features indicated.

In the description of the present disclosure, unless otherwise clearly defined, the terms such as “dispose”, “install” and “connect” shall be understood in a broad sense. A person skilled in the art can reasonably determine the specific meanings of the above terms in the present disclosure in combination with specific contents of the technical scheme.

The embodiments of the present disclosure are further elaborated below with reference to the accompanying drawings.

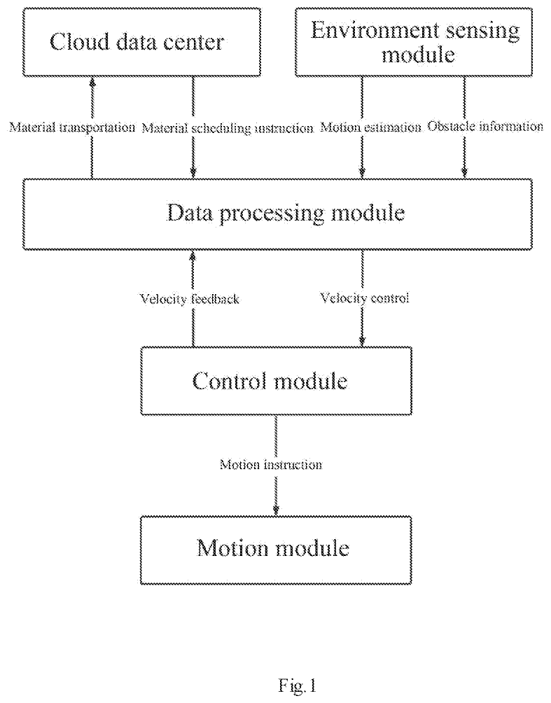

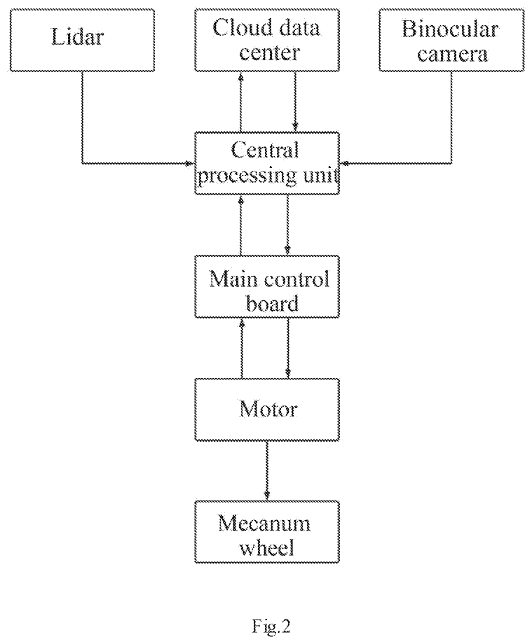

As shown in FIGS. 1-2, an intelligent medical material supply robot based on Internet of Things and SLAM technology according to an embodiment in a first aspect of the present disclosure includes:

an environment sensing module provided with a binocular camera and a lidar, wherein the binocular camera acquires image information by real-time shooting, and the lidar obtains map information by sensing spatial information;

a data processing module for analyzing the image information captured by the binocular camera, making incremental calculation of position and pose of the robot based on inter-frame information in the image information, and completing judgment on a static obstacle and a dynamic obstacle by analyzing the map information sensed by the lidar, so that the robot achieves localization, mapping and automatic obstacle avoidance functions;

a motion module provided with a Mecanum wheel and a motor, wherein the Mecanum wheel is driven by the motor to move in any direction on the horizontal plane can be realized by programming, so that the material supply robot can move in a narrow space;

a control module provided with a central processing unit for receiving and processing the data acquired by the environment sensing module and a main control board for controlling the motion module, thereby controlling rotation of the Mecanum wheel and using a control algorithm to control the robot to stably move; and

a cloud data center comprising a cloud server, configured for analyzing material usage at current and previous moments and transmitting the data to the control module to realize intelligent scheduling of the material supply robot to go to a designated place to complete the delivery of medical materials.

The robot can be used to replace the medical staff to carry medical materials to designated locations, saving manpower and improving transportation efficiency. Once any type of material is insufficient in a material site, the cloud data center, after learning the situation through monitoring, will comprehensively consider the urgency of a task, a target distance, the quantity of materials and other information and intelligently schedule an idle material supply robot to autonomously navigate and transport a variety of medical materials to a single or multiple material sites to complete a transportation task assigned by the cloud data center. The material supply robot can load and unload medical materials independently, completely replacing the traditional human transportation.

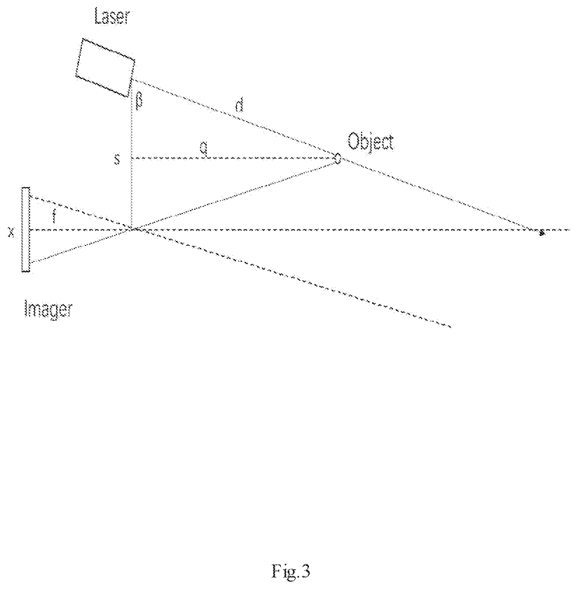

In some specific embodiments of the present disclosure, the lidar emits a laser beam which will reflect when encountering an obstacle, and a real distance between the robot and the obstacle can be calculated according to the similar triangle principle. FIG. 3 is a schematic diagram of lidar triangulation ranging, and its calculation formula is as follows:

$$q = \frac{fs}{x}$$

$$d = \frac{q}{sin β}$$

$$\frac{dq}{dx} = - \frac{{q}^{2}}{fs}$$

where an emission angle β is a known quantity, q is a measured distance, s is a distance between a laser head and a lens, f is a focal length of the lens, and x corresponds to s in an imager.

In some specific embodiments of the present disclosure, the main control board disposed on the control module can process a control instruction issued by the central processing unit, the driving velocity, orientation and other information of the Mecanum wheels. The control module adopts a PID adjustment algorithm, and a calculation formula of its control law is as follows:

$$u ( t ) = {k}_{p} [ error ( t ) + \frac{1}{{T}_{t}} {\int }_{0}^{t} error ( t ) dt + \frac{{T}_{D} derror ( t )}{dt} ]$$

$$error ( t ) = {y}_{d} ( t ) - y ( t )$$

where K is a proportionality coefficient, TI is an integral time constant, TD is a differential time constant, error(t) is a deviation signal, yd(t) is a given value, and y(t) is an output value. The difference between yd(t) and y(t) is an error value, i.e., the deviation signal.

In some specific embodiments of the present disclosure, the motion module comprises four Mecanum wheels and four motors. Under the control of the main control board, the velocity of the four Mecanum wheels is driven by four independent motors, and the four Mecanum wheels can move in any direction on the horizontal plane by programming, so that the material supply robot can move in a narrow space.

In some specific embodiments of the present disclosure, the Mecanum wheels are mounted in a 0-rectangle mode. The rotation of the wheels can generate a rotation torque of a yaw axis, and a moment arm of the rotation torque is also relatively long.

In some specific embodiments of the present disclosure, the omnidirectional movement of the Mecanum wheel(s) is realized by using forward and inverse kinematics models. The forward kinematics model can calculate a motion state of a chassis based on the velocity of the four wheels, while the inverse kinematics model can calculate the velocity of the four wheels based on the motion state of the chassis.

In some specific embodiments of the present disclosure, the binoculars in the binocular camera are modulated by hardware to be absolutely synchronous and output image data at the same time. Therefore, information of image depth can be acquired, the relative motion of the robot can be estimated according to an interframe matching algorithm, and an error function composed of re-projection errors is constructed. Position and pose of the robot can be adjusted by using a nonlinear optimization algorithm to achieve a purpose of long-time outputting of high-accuracy position and pose.

In some specific embodiments of the present disclosure, the data processing module constructs a map by using the SLAM technology based on an ROS system, builds an open source package Cartographer by calling a currently perfect map, uses information from the laser and a visual odometer to generate a two-dimensional map, and eliminates errors generated during composition through closed-loop detection. A basic unit for the closed-loop detection is a submap. A submap comprises a certain number of laser scans. When a laser scan is inserted into its corresponding submap, its optimal location in the submap may be estimated based on an existing laser scan and other sensor data of the submap. Error accumulation of the creation of the submap over a short period of time is considered to be sufficiently small. However, as increasingly more submaps are created over time, the error accumulation between the submaps increases. Therefore, it is necessary to properly optimize position and pose of these submaps through closed-loop detection to eliminate these accumulated errors, which transforms the problem into a position and pose optimization problem. When the construction of a submap is completed, that is, when no new laser scan is inserted into the submap, the submap will be added to the closed-loop detection. All submaps that have been created will be considered in the closed-loop detection. When a new laser scan is added to the map, if an estimated position and pose of the laser scan is close to those of a laser scan of a submap in the map, the closed loop will be found by a scan match strategy. The scan match strategy in the Cartographer takes a window near the estimated position and pose of the laser scan newly added to the map, and then looks for a possible match of the laser scan in the window. If a good enough match is found, closed-loop constraint of the match will be added to the position and pose optimization problem. The Cartographer focuses on the creation of a local submap that fuses multi-sensor data and the implementation of a scan match strategy for closed-loop detection.

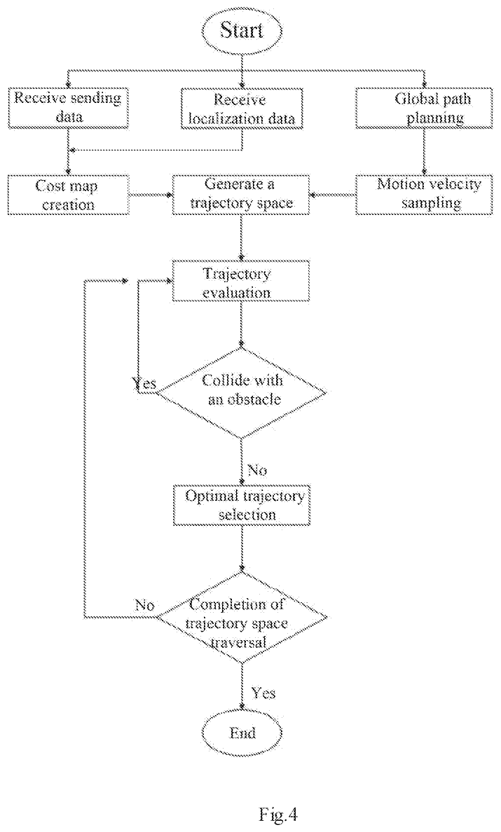

In some specific embodiments of the present disclosure, when a scheduling instruction is received from the cloud data center, it is firstly analyzed according to received sensing data and localization data to create a grid map and a cost map, a search for a global optimal path is completed by using an Astar path planning algorithm, and an automatic obstacle avoidance algorithm Dynamic Window Approach (DWA) is used on the way to the target point. FIG. 4 is a flowchart thereof. Motion trajectory of the robot is adjusted in real time to achieve dynamic obstacle avoidance. According to the DWA algorithm, multiple groups of velocities in a velocity space are sampled first and trajectories of the robot in a certain period of time under these velocities are simulated. After multiple groups of trajectories are obtained, these trajectories are evaluated, and the velocity corresponding to the optimal trajectory is selected to drive the robot.

In some specific embodiments of the present disclosure, after the material supply robot arrives at a corresponding material loading area, the staff of a material storage warehouse will load required materials for the robot according to a list of materials displayed on a robot interactive interface, and mark a storage position of each material on the robot body on the interactive interface. After the loading is completed, an instruction is sent through the interactive interface to enable the robot to begin autonomous transportation. The robot will plan a transportation journey according to the distance of the target position of each transportation task and a priority level of the task. After arriving at a designated target point, information of to-be-unloaded materials will be displayed on the interactive interface. After the unloading is completed, the medical staff will issue an instruction through the interactive interface to enable the supply robot to perform a next task. If the medical staff take the materials not included in the unloading list or not all of them, they also need to register through the interactive interface. Registration information will be uploaded to the cloud data center which will allocate the supply robot to continue to complete the remaining transportation tasks or return to the warehouse for loading and unloading materials according to the remaining materials and task information.

The intelligent medical material supply robot based on Internet of Things and SLAM technology according to the embodiment of the present disclosure can achieve at least some of the following effects through the above setting: localization and mapping are realized through a binocular camera and a lidar. A cloud data center schedules the medical material supply robot in real time according to material usage. The material supply robot receives corresponding scheduling information, and according to localization of the robot and the map information, dynamically avoids obstacles by using a path planning algorithm to go to a designated floor for materials delivery. The robot can be used to replace the medical staff to carry medical materials to designated locations, saving manpower and improving transportation efficiency. Once any type of material is insufficient in a material site, the cloud data center, after learning the situation through monitoring, will comprehensively consider the urgency of a task, a target distance, the quantity of materials and other information and intelligently schedule an idle material supply robot to autonomously navigate and transport a variety of medical materials to a single or multiple material sites to complete a transportation task assigned by the cloud data center. The material supply robot can load and unload medical materials independently, completely replacing the traditional human transportation.

In the description in this specification, the description with reference to the term “one embodiment,” “some embodiments,” “example,” “specific example” or “some examples” means that a specific feature, structure, material or characteristic described in combination with the embodiment or example is included in at least one embodiment or example in the present disclosure. In this specification, the schematic expression of the above term is not necessarily directed to the same embodiment or example. Moreover, the described specific feature, structure, material or characteristic may be combined in a proper manner in any one or more embodiments or examples.

Although the embodiments of the present disclosure have been illustrated and described, a person of ordinary skill in the art can understand that various changes, modifications, replacements and transformations can be made to these embodiments without departing from the principle and purpose of the present disclosure. The scope of the present disclosure is defined by the claims and their equivalents.

We claim:

1. An intelligent medical material supply robot based on Internet of Things and SLAM technology, comprising:
an environment sensing module provided with a binocular camera and a lidar, wherein the binocular camera acquires image information by real-time shooting, and the lidar obtains map information by sensing spatial information;
a data processing module for analyzing the image information captured by the binocular camera, making incremental calculation of position and pose of the robot based on inter-frame information in the image information, and completing judgment on a static obstacle and a dynamic obstacle by analyzing the map information sensed by the lidar;
a motion module provided with a Mecanum wheel and a motor, wherein the Mecanum wheel is driven by the motor;
a control module provided with a central processing unit for receiving and processing the data acquired by the environment sensing module and a main control board for controlling the motion module; and
a cloud data center comprising a cloud server, configured for analyzing material usage at current and previous moments and transmitting the data to the control module.

2. The intelligent medical material supply robot of claim 1, wherein the lidar emits a laser beam which will reflect when encountering an obstacle, and a distance between the robot and the obstacle is calculated by the lidar based on the following calculation formulas:
$$q = \frac{fs}{x}$$
$$d = \frac{q}{sin β}$$
$$\frac{dq}{dx} = - \frac{{q}^{2}}{fs}$$
wherein an emission angle β is a known quantity, q is a measured distance, s is a distance between a laser head and a lens, f is a focal length of the lens, and x corresponds to s in an imager.

3. The intelligent medical material supply robot of claim 1, wherein the control module adopts a PID adjustment algorithm, and a calculation formula of its control law is as follows:
$$u ( t ) = {k}_{p} [ error ( t ) + \frac{1}{{T}_{t}} {\int }_{0}^{t} error ( t ) dt + \frac{{T}_{D} derror ( t )}{dt} ]$$
$$error ( t ) = {y}_{d} ( t ) - y ( t )$$
wherein K is a proportionality coefficient, T_{I} is an integral time constant, T_{D} is a differential time constant, error(t) is a deviation signal, y_{d}(t) is a given value, and y(t) is an output value.

4. The intelligent medical material supply robot of claim 1, wherein the motion module comprises four Mecanum wheels and four motors corresponding to the Mecanum wheels one by one, and the Mecanum wheels are driven by the motors to move in any direction on a horizontal plane under the control of the main control board.

5. The intelligent medical material supply robot of claim 1, wherein the omnidirectional movement of the Mecanum wheel(s) is realized by using forward and inverse kinematics models.

6. The intelligent medical material supply robot of claim 4, wherein the omnidirectional movement of the Mecanum wheel(s) is realized by using forward and inverse kinematics models.

7. The intelligent medical material supply robot of claim 1, wherein the data processing module constructs a map by using the SLAM technology based an ROS system.

8. The intelligent medical material supply robot of claim 1, wherein after giving a target point, the cloud data center first determines the robot's current position and pose, calculates a distance between the robot and an obstacle by the lidar, converts obstacle information into a grid map applicable to path planning, calculates, by using a global path planning algorithm, an optimal path that the robot can move along currently, constantly senses changes of environment information in the process of moving, and avoids dynamic obstacles by using a local path planning algorithm.
